(19) United States
(12) Patent Application Publication
(10) Pub. No.: US 2018/0160405 A1
(43) Pub. Date: Jun. 7, 2018

(54) RATE MATCHING AND SIGNALING

(71) Applicant: QUALCOMM Incorporated, San Diego, CA (US)

(72) Inventors: Sony AKKARAKARAN, Poway, CA (US); Tao LUO, San Diego, CA (US); Makesh Pravin JOHN WILSON, San Diego, CA (US); Sumeeth NAGARAJA, San Diego, CA (US)

(21) Appl. No.: 15/708,990

(22) Filed: Sep. 19, 2017

Related U.S. Application Data
(60) Provisional application No. 62/429,568, filed on Dec. 2, 2016.

(51) Int. Cl. H04W 72/04; H04W 72/12; H04W 88/06

(52) U.S. Cl. CPC H04W 72/042; H04W 72/1289; H04W 72/0486; H04W 72/044; H04W 88/06

(57) ABSTRACT

The present disclosure describes a method, an apparatus, and a computer-readable medium for wireless communications at a user equipment. For example, the method may receive a numerology of a signal received from a base station, wherein the numerology indicates one or more parameters of a waveform associated with the signal. The example method may further perform a rate matching based at least on the numerology, wherein the rate matching is performed for decoding the signal received from the base station. Additionally, in another example, a method for wireless communications at a base station is provided. The method includes performing a rate matching at the base station based at least on a numerology which is known at the base station. The rate matching is performed for decoding the signal received from a user equipment.

### CLAIM OF PRIORITY

The present application for patent claims priority to U.S. Provisional Patent Application No. 62/429,568, filed Dec. 2, 2016, entitled “Rate Matching and Signaling,” which is assigned to the assignee hereof, and hereby expressly incorporated by reference herein.

### BACKGROUND

Aspects of the present disclosure relate generally to wireless communication networks, and more particularly, to rate matching.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as new radio (NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

For example, for NR communications technology and beyond, mixed and/or multiple numerologies are supported. Thus, there is a desire for rate matching.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of a wireless communication network including at least one user equipment (UE) having a rate matching component and at least one base station having a corresponding rate matching component configured according to this disclosure for rate matching.

FIG. 2A is a diagram illustrating an example of a DL frame structure.

FIG. 2B is a diagram illustrating an example of channels within the DL frame structure.

FIG. 2C is a diagram illustrating an example of an UL frame structure.

FIG. 2D is a diagram illustrating an example of channels within the UL frame structure.

FIG. 3 is an example flow diagram of an method of wireless communications, according to an aspect of the present disclosure.

FIG. 4 is a schematic diagram of example components of the UE of FIG. 1.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one example, a method for wireless communications is provided. The method includes receiving, at a user equipment (UE), a numerology of a signal received from a base station, wherein the numerology indicates one or more parameters of a waveform associated with the signal. The method further includes performing, at the UE, a rate matching based at least on the numerology, wherein the rate matching is performed for decoding the signal received from the base station.

In another example, an apparatus for wireless communications at a UE is provided. The apparatus includes a memory configured to store data; and one or more processors communicatively coupled with the memory, wherein the one or more processors and the memory are configured to receive, at a user equipment (UE), a numerology of a signal received from a base station, wherein the numerology indicates one or more parameters of a waveform associated with the signal; and perform, at the UE, a rate matching based at least on the numerology, wherein the rate matching is performed for decoding the signal received from the base station.

In a further example, another apparatus for wireless communications is provided. The apparatus includes means for receiving, at a user equipment (UE), a numerology of a signal received from a base station, wherein the numerology indicates one or more parameters of a waveform associated with the signal; and means for performing, at the UE, a rate matching based at least on the numerology, wherein the rate matching is performed for decoding the signal received from the base station.

Furthermore, in another example, a computer readable medium storing computer executable code for wireless communications is provided. The computer readable medium includes code for receiving, at a user equipment (UE), a numerology of a signal received from a base station, wherein the numerology indicates one or more parameters of a waveform associated with the signal; and code for performing, at the UE, a rate matching based at least on the numerology, wherein the rate matching is performed for decoding the signal received from the base station.

Additionally, in another example, a method for wireless communications is provided. The method includes performing, at a base station, a rate matching based at least on a numerology, wherein the rate matching is performed for decoding the signal received from a user equipment (UE). The numerology is known at the base station.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The present disclosure generally relates to performing rate matching at a receiver based on numerology received from a transmitter. Rate-matching can be generally defined as the process of repeating or dropping certain bits in a bit-stream so that the output bit-stream has the correct number of bits to be modulation-mapped onto a given set of channel resources, e.g., resource elements. For instance, when a channel, e.g., channel “A” is rate-matched around another channel, e.g., channel “B,” the rate-matching procedure for channel A does not consider the channel resources occupied by channel B as being among the available channel resources for channel A. Additionally, when channel A is punctured by channel B, the resources occupied by channel B are counted as being among the available channel resources for the purpose of the rate matching and modulation mapping procedures, but some of the channel A modulation symbols, which are thus mapped to these resources, are then replaced by the modulation symbols for channel B.

In one example, the receiver may be a UE and the transmitter may be a base station. In another example, the transmitter may be a UE and the receiver may be a base station. The base station may indicate the numerology to the receiver via signaling. The signaling may be physical layer signaling (e.g., using a control channel), media access control-control element (MAC-CE), and/or radio resource control (RRC) signaling. The receiver uses the received numerology received to perform rate matching at the receiver and decoding of the transmission.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to 5G networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

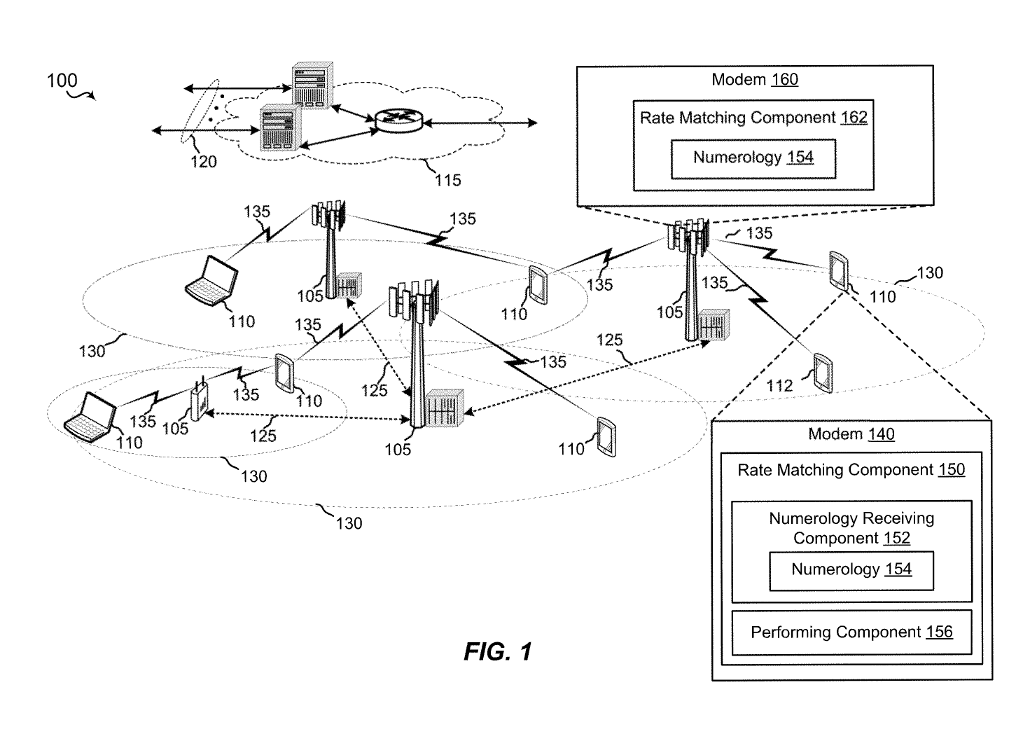

Referring to FIG. 1, in accordance with various aspects of the present disclosure, an example wireless communication network 100 includes at least one UE 110 with a modem 140 having a rate matching component 150 that manages rate matching (also referred to as dynamic rate matching) at UE 110. Further, wireless communication network 100 includes at least one base station (or an eNB) 105 with a modem 160 having a corresponding rate matching component 162 that manages rate matching at base station 105.

For example, UE 110 and/or the rate matching component 150 may receive a numerology (e.g., numerology 154) of a signal received from base station 105. Numerology 154 indicates one or more parameters of a waveform associated with the signal received from base station 105. In an aspect, he one or more parameters received from base station 105 may include a subcarrier spacing and/or a cyclic prefix. UE 110 may receive the one or more parameters, from base station 105, via layer one (L1) or radio resource control (RRC) signaling, a media access control-control element (MAC-CE), a master information block (MIB), a system information block (SIB), or a combination thereof. UE 110 uses the one or more parameters to perform rate matching at the UE for decoding a signal, e.g., 135, received from the base station.

In an aspect, UE 110 may include a modem 140 and/or rate matching component 150 for wireless communications (e.g., rate matching). Rate matching component 150 may further include a numerology receiving component 152 for receiving numerology 154 from base station 105 and/or a performing component 156 for performing a rate matching based at least on the numerology. In an additional aspect, base station 105 may include a modem 160 and/or rate matching component 162 for wireless communications (e.g., rate matching). Rate matching component 162 may perform, at base station 105, a rate matching based at least on a numerology, e.g., numerology 154, known at base station 105. The rate matching is performed at base station 105 for decoding the signal received at base station 105 from UE 110.

The wireless communication network 100 may include one or more base stations 105, one or more UEs 110, and a core network 115. The core network 115 may provide user authentication, access authorization, tracking, internet protocol (IP) connectivity, and other access, routing, or mobility functions. The base stations 105 may interface with the core network 115 through backhaul links 120 (e.g., S1, etc.). The base stations 105 may perform radio configuration and scheduling for communication with UEs 110, or may operate under the control of a base station controller (not shown). In various examples, the base stations 105 may communicate, either directly or indirectly (e.g., through core network 115), with one another over backhaul links 125 (e.g., X1, etc.), which may be wired or wireless communication links.

The base stations 105 may wirelessly communicate with UEs 110 via one or more base station antennas. Each of the base stations 105 may provide communication coverage for a respective geographic coverage area 130. In some examples, base stations 105 may be referred to as a base transceiver station, a radio base station, an access point, an access node, a radio transceiver, a NodeB, eNodeB (eNB), gNB, Home NodeB, a Home eNodeB, a relay, or some other suitable terminology. The geographic coverage area 130 for a base station 105 may be divided into sectors or cells making up only a portion of the coverage area (not shown). The wireless communication network 100 may include base stations 105 of different types (e.g., macro base stations or small cell base stations, described below). Additionally, the plurality of base stations 105 may operate according to different ones of a plurality of communication technologies (e.g., 5G (New Radio or “NR”), fourth generation (4G)/LTE, 3G, Wi-Fi, Bluetooth, etc.), and thus there may be overlapping geographic coverage areas 130 for different communication technologies.

In some examples, the wireless communication network 100 may be or include one or any combination of communication technologies, including a NR or 5G technology, a Long Term Evolution (LTE) or LTE-Advanced (LTE-A) or MuLTEfire technology, a Wi-Fi technology, a Bluetooth technology, or any other long or short range wireless communication technology. In LTE/LTE-A/MuLTEfire networks, the term evolved node B (eNB) may be generally used to describe the base stations 105, while the term UE may be generally used to describe UEs 110. The wireless communication network 100 may be a heterogeneous technology network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may generally cover a relatively large geographic area (e.g., several kilometers in radius) and may allow unrestricted access by UEs 110 with service subscriptions with the network provider.

A small cell may include a relative lower transmit-powered base station, as compared with a macro cell, that may operate in the same or different frequency bands (e.g., licensed, unlicensed, etc.) as macro cells. Small cells may include pico cells, femto cells, and micro cells according to various examples. A pico cell, for example, may cover a small geographic area and may allow unrestricted access by UEs 110 with service subscriptions with the network provider. A femto cell may also cover a small geographic area (e.g., a home) and may provide restricted access and/or unrestricted access by UEs 110 having an association with the femto cell (e.g., in the restricted access case, UEs 110 in a closed subscriber group (CSG) of base station 105, which may include UEs 110 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The communication networks that may accommodate some of the various disclosed examples may be packet-based networks that operate according to a layered protocol stack and data in the user plane may be based on the IP. A user plane protocol stack (e.g., packet data convergence protocol (PDCP), radio link control (RLC), MAC, etc.), may perform packet segmentation and reassembly to communicate over logical channels. For example, a MAC layer may perform priority handling and multiplexing of logical channels into transport channels. The MAC layer may also use hybrid automatic repeat/request (HARQ) to provide retransmission at the MAC layer to improve link efficiency. In the control plane, the RRC protocol layer may provide establishment, configuration, and maintenance of an RRC connection between a UE 110 and the base stations 105. The RRC protocol layer may also be used for core network 115 support of radio bearers for the user plane data. At the physical (PHY) layer, the transport channels may be mapped to physical channels.

UEs 110 may be dispersed throughout the wireless communication network 100, and each UE 110 may be stationary or mobile. A UE 110 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 110 may be a cellular phone, a smart phone, a personal digital assistant (PDA), a wireless modem, a wireless communication device, a handheld device, a tablet computer, a laptop computer, a cordless phone, a smart watch, a wireless local loop (WLL) station, an entertainment device, a vehicular component, a customer premises equipment (CPE), or any device capable of communicating in wireless communication network 100. Additionally, a UE 110 may be Internet of Things (IoT) and/or machine-to-machine (M2M) type of device, e.g., a low power, low data rate (relative to a wireless phone, for example) type of device, that may in some aspects communicate infrequently with wireless communication network 100 or other UEs. A UE 110 may be able to communicate with various types of base stations 105 and network equipment including macro eNBs, small cell eNBs, macro gNBs, small cell gNBs, relay base stations, and the like.

UE 110 may be configured to establish one or more wireless communication links 135 with one or more base stations 105. The wireless communication links 135 shown in wireless communication network 100 may carry uplink (UL) transmissions from a UE 110 to a base station 105, or downlink (DL) transmissions, from a base station 105 to a UE 110. The downlink transmissions may also be called forward link transmissions while the uplink transmissions may also be called reverse link transmissions. Each wireless communication link 135 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. In an aspect, the wireless communication links 135 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2). Moreover, in some aspects, the wireless communication links 135 may represent one or more broadcast channels.

In some aspects of the wireless communication network 100, base stations 105 or UEs 110 may include multiple antennas for employing antenna diversity schemes to improve communication quality and reliability between base stations 105 and UEs 110. Additionally or alternatively, base stations 105 or UEs 110 may employ multiple input multiple output (MIMO) techniques that may take advantage of multi-path environments to transmit multiple spatial layers carrying the same or different coded data.

Wireless communication network 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 110 may be configured with multiple downlink CCs and one or more uplink CCs for carrier aggregation. Carrier aggregation may be used with both FDD and TDD component carriers. The base stations 105 and UEs 110 may use spectrum up to Y MHz (e.g., Y=5, 10, 15, or 20 MHz) bandwidth per carrier allocated in a carrier aggregation of up to a total of Yx MHz (x=number of component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications network 100 may further include base stations 105 operating according to Wi-Fi technology, e.g., Wi-Fi access points, in communication with UEs 110 operating according to Wi-Fi technology, e.g., Wi-Fi stations (STAs) via communication links in an unlicensed frequency spectrum (e.g., 5 GHz). When communicating in an unlicensed frequency spectrum, the STAs and AP may perform a clear channel assessment (CCA) or listen before talk (LBT) procedure prior to communicating in order to determine whether the channel is available.

Additionally, one or more of base stations 105 and/or UEs 110 may operate according to a NR or 5G technology referred to as millimeter wave (mmW or mmwave) technology. For example, mmW technology includes transmissions in mmW frequencies and/or near mmW frequencies. Extremely high frequency (EHF) is part of the radio frequency (RF) in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. For example, the super high frequency (SHF) band extends between 3 GHz and 30 GHz, and may also be referred to as centimeter wave. Communications using the mmW and/or near mmW radio frequency band has extremely high path loss and a short range. As such, base stations 105 and/or UEs 110 operating according to the mmW technology may utilize beamforming in their transmissions to compensate for the extremely high path loss and short range.

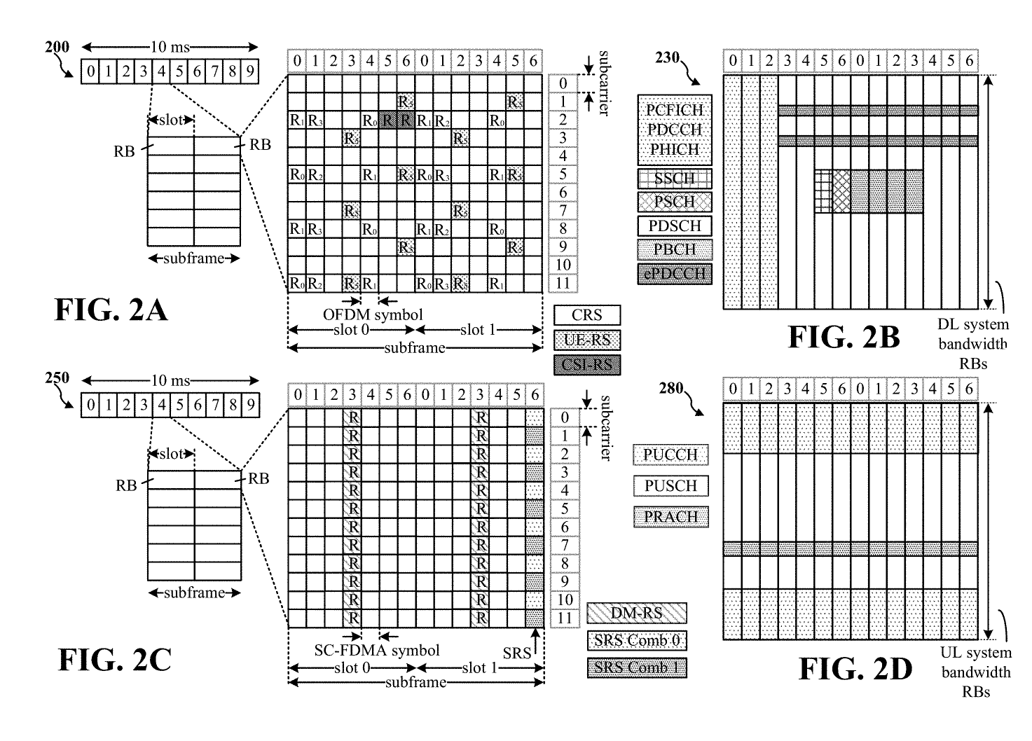

FIG. 2A is a diagram 200 illustrating an example of a DL frame structure in LTE, which may be an example of a frame structure that may be transmitted by at least one base station 105 configured with rate matching component 105 for rate matching in accordance with various aspects of the present disclosure. FIG. 2B is a diagram 230 illustrating an example of channels within the DL frame structure in LTE that may be transmitted by base station 105 and used by UE 110 as described herein. FIG. 2C is a diagram 250 illustrating an example of an UL frame structure in LTE that may be used by UE 110. FIG. 2D is a diagram 280 illustrating an example of channels within the UL frame structure in LTE that may be used by UE 110. Other wireless communication technologies may have a different frame structure and/or different channels.

In LTE, a frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). In LTE, for a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme. Additionally, the RBs described above may also be referred to as “resources,” “orthogonal resources,” etc. in the present disclosure.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R0, R1, R2, and R3, respectively), UE-RS for antenna port 5 (indicated as R5), and CSI-RS for antenna port 15 (indicated as R).

FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) is within symbol 6 of slot 0 within subframes 0 and 5 of a frame, and carries a primary synchronization signal (PSS) that is used by a UE to determine subframe timing and a physical layer identity. The secondary synchronization channel (SSCH) is within symbol 5 of slot 0 within subframes 0 and 5 of a frame, and carries a secondary synchronization signal (SSS) that is used by a UE to determine a physical layer cell identity group number. Based on the physical layer identity and the physical layer cell identity group number, the UE can determine a physical cell identifier (PCI). Based on the PCI, the UE can determine the locations of the aforementioned DL-RS. The physical broadcast channel (PBCH) is within symbols 0, 1, 2, 3 of slot 1 of subframe 0 of a frame, and carries a master information block (MIB). The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

For example, when performing rate matching, REs that are assigned to synchronization signals (e.g., PSS, SSS, etc.) may be skipped during the mapping PDSCH modulation symbols to PDSCH REs. In one example aspect, the PDSCH modulation symbols may be mapped assuming that CSI-RS REs are also available for PDSCH. However, after completion of the mapping, the PDSCH modulation symbols occupying the CSI-RS REs may be replaced by the CSI-RS symbols.

As illustrated in FIG. 2C, some of the REs carry demodulation reference signals (DM-RS) for channel estimation at the eNB. The UE may additionally transmit sounding reference signals (SRS) in the last symbol of a subframe. The SRS may have a comb structure, and a UE may transmit SRS on one of the combs. The SRS may be used by an eNB for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

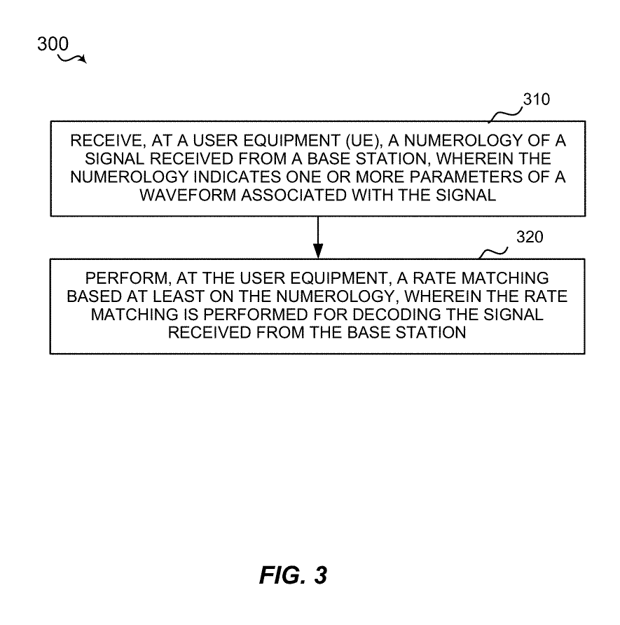

FIG. 3 is a flowchart illustrating an example method 300 for wireless communications at a UE.

In an aspect, at block 310, methodology 300 may include receiving, at a user equipment (UE), a numerology of a signal received from a base station, wherein the numerology indicates one or more parameters of a waveform associated with the signal. For example, in an aspect, UE 112 and/or rate matching component 150 may include numerology receiving component 152, such as a specially programmed processor module, or a processor executing specially programmed code stored in a memory to receive, at UE 110, a numerology, e.g., numerology 154, of a signal (or a resource, e.g., a resource block (RB)) received from base station 105. As described above, numerology 154 indicates one or parameters of the waveform associated with the signal. For example, the one or more parameters may include one or more of a subcarrier spacing, cyclic prefix, etc. A subcarrier spacing may be generally defined as a spacing between subcarriers, e.g., LTE subcarriers. A cyclic prefix generally refers to the prefix of a symbol with a repetition of the end.

In an aspect, UE 110 may receive numerology 154 from base station 105. UE 110 may receive numerology 154 via a layer one (L1) or radio resource control (RRC) signaling, a media access control-control element (MAC-CE), a master information block (MIB), a system information block (SIB), or a combination thereof. This provides flexibility in transmitting the numerology 154 to UE 110.

In an aspect, at block 320, methodology 300 may include performing, at the UE, a rate matching based at least on the numerology, wherein the rate matching is performed for decoding the signal received from the base station. For example, in an aspect, UE 112 and/or rate matching component 150 may include performing component 156, such as a specially programmed processor module, or a processor executing specially programmed code stored in a memory to perform, at UE 112, a rate matching based at least on numerology 154. UE 112 performs the rate matching for decoding the signal received from the base station, e.g., for decoding downlink transmissions received from base station 105 at UE 110.

The parameters (e.g., one or more parameters) indicated by base station 105 via numerology 154 may impact rate matching behavior at UE 110. For example, subcarrier spacing may be defined as a distance between two consecutive subcarriers in a frequency domain, and the distance may be, e.g., 30 KHz, 60 KHz, 120 KHz, etc. However, additional signaling may be needed to support dynamic or mixed numerology as the procedure for rate matching around reference signals has to be supported. In an additional aspect, numerology 154 may further include a bandwidth of the signal (or resource) which may be a partial bandwidth of a system bandwidth (e.g., sub-band, etc.) or RRC configured bandwidth for rate matching purposes. In a further additional aspect, numerology 154 may indicate a location of the signal (or resources), e.g., which symbol and/or how many symbols.

In an aspect, base station 105 may schedule one or more UEs, e.g., UE 110 and/or UE 112 in a multi-user-multiple-input and multiple-output (MU-MIMO) configuration using shared resources. The shared resources may be resource blocks (RBs) which include resource elements (REs), as illustrated in FIGS. 2A-2D, on which modulation symbols carrying data bits are mapped. In one example, the resources for two different UEs (or two different groups of UEs) may be the same. In another example, some of the resources may be common to the two different UEs (or two different groups of UEs), e.g., overlapping resources between the two different UEs or the two different groups of UEs. In such cases, for example, when base station 105 is the transmitter, the rate matching is performed at a receiver, e.g., at UE 110 or the UE 112. The rate matching may have to be performed at the receiver as information bits received in a packet at the receiver may have to be mapped to the resources, e.g., modulated symbols, as data may not be transmitted over all resources (e.g., data for a UE may be transmitted over some resource or symbols only). For example, as the number of bits the encoder outputs depends on the type of encoding, the number of bits may not match the number of resource elements in a resource block.

Base station 105 may indicate numerology 154 of the signal/resource to one or more UEs or to one or more groups of UEs. The indication of numerology 154 from base station 105 assists in the rate matching that may be performed at the receiver, e.g., UE 110 or UE 112. Additionally/optionally, the receiver may be base station 105 if the UE (e.g., UE 110 or 112) is the transmitter for transmissions on uplink to base station 105.

Base station 105 may indicate numerology 154 to UEs via physical layer signaling (e.g., using a control channel), media access control-control element (MAC-CE) signaling, radio resource control (RRC) signaling, a master information block (MIB), a system information block (SIB), and/or any combination thereof. Base station 105 may broadcast information, e.g., master information block (MIB) and/or system information blocks (SIBs) using a fixed numerology or a sub-set of numerologies. The receiving UEs, e.g., UE 110, may decode the MIB and/or the SIBs, perform a random access (RACH) procedure, and/or may receive/transmit RRC reconfiguration messages related to rate matching.

In one example, base station 105 may use a first subcarrier spacing (e.g., 60 KHz) for transmission of control and/or user data to a first UE or a first group of UEs (e.g., UE 110), and/or use a second subcarrier spacing (e.g., 120 KHz) for transmission of control and/or user data to a second UE or a second group of UEs (e.g., UE 112). Base station 105 may indicate (e.g., notify, signal, etc.) to UE 110, for example, via numerology 154, to perform rate matching around the signal/resource element with 60 KHz subcarrier spacing. Base station 105 may also notify UE 112 to perform rate signal/resource element with 120 KHz subcarrier spacing which may result in UE 112 performing rate matching with twice the number of symbols, as UE 112 is using symbols for a time duration which is half of the symbol duration of UE 110. In other words, UE 110 may perform rate matching around signal/resource element with a subcarrier spacing of 60 KHz for a time duration “T1” and/or UE 112 may perform rate matching around signal/resource element with a subcarrier spacing of 120 KHz for a time duration “2T2,” and 2T2=T1. This allows the signal/resource element that is rate matched to be free from interference from data symbols sent to both UE 110 and UE 112. In some aspects, rate matching around signal/resource element transmitted to another UE may not be needed if mutual interference between the transmissions to the UEs is limited due to spatial separation between the signals/resource elements.

In another example, base station 105 may use a subcarrier spacing 60 KHz for control signaling and/or user data for a UE or a group of UEs. Base station 105 may dynamically update (e.g., revise, change, modify, etc.) numerology 154, for example, for the user data portion, by changing the subcarrier spacing to, e.g., 120 KHz (from 60 KHz) and notifying UE 110. Base station 105 may notify UE 110 about the updated numerology so that UE 110 may perform rate matching for the user data based on the updated numerology, e.g., a subcarrier spacing of 120 KHz. Base station 105 may dynamically notify UE 110 of the updated numerology via L1 or physical layer (e.g., using a control channel) or RRC signaling, media access control-control element (MAC-CE), RRC signaling, a MIB, a SIB, and/or any combination thereof.

In an aspect, base station 105 may indicate to UE 110 to perform rate matching in different ways. In one example, base station 105 may notify UE 110 to perform rate matching with the same amount of time duration. That is, when base station 105 initially scheduled transmission of control signaling with 60 KHz subcarrier spacing, the resources (e.g., REs) for rate matching may have a duration of 1 symbol corresponding to 60 KHz tone spacing. However, when base station 105 dynamically updates the subcarrier spacing for user data to 120 KHz, the resources for rate-matching may have a duration of 2 symbols corresponding to 120 KHz subcarrier spacing as the typical time duration of a symbol with 120 KHz subcarrier spacing is half the time duration of a corresponding symbol with 60 KHz subcarrier spacing. Additionally, base station 105 may signal UE 110 to rate match the resources with the same number of symbols. For example, when base station 105 schedules user data for UE 110 with a subcarrier spacing of 60 KHz, the resources for rate matching have a duration of 1 symbol corresponding to 60 KHz subcarrier spacing. However, when base station 105 dynamically updates the subcarrier spacing for user data to 120 KHz, the resources for performing rate-matching have a duration of 1 symbol corresponding to the 120 KHz subcarrier spacing (half the duration with 60 KHz subcarrier spacing).

Base station 105 may indicate numerology 154 to UEs using one or more reserved bits. For example, a sub-set of values based on reserved-bits may be used to indicate a “default” numerology so that other additional information may be carried in the one or more reserved bits, for example, for efficient communications. In an aspect, default numerology could be, for example, same numerology used by physical channels that are being rate-matched around the reserved resources, e.g., for transmission of reference signals.

Additionally, the downlink rate matching scheme may be re-used for uplink rate matching scheme. That is, when UE 110 transmits a physical uplink shared channel (PUSCH) and/or a control channel on the uplink to base station 105, UE 110 may signal to base station 105 to perform rate matching using the same numerology (e.g., numerology 154) received from base station 105 and used for performing rate matching for downlink transmissions. The signals/REs around which rate matching is reused may include resources used for a sounding reference signal (SRS), resources used for a reference signal for uplink beam management, resources used for a reference signal for uplink channel or interference sounding purposes, and/or resources used for forward compatibility purposes. Further, the signals transmitted in these resources may be signals from the UE performing the rate matching or from other UEs. In other words, a UE may perform rate matching around REs that are used for other purposes by either the same UE or by other UEs. For example, as OFDM is supported on the UL in addition to SC-FDM, downlink rate matching scheme may be reused for both OFDM and SC-FDM waveform transmission on both downlink and uplink. The disclosure describes the rate matching mechanism at a UE. However, the rate mechanism may be used at the base station as well for uplink transmissions from the UE to the base station.

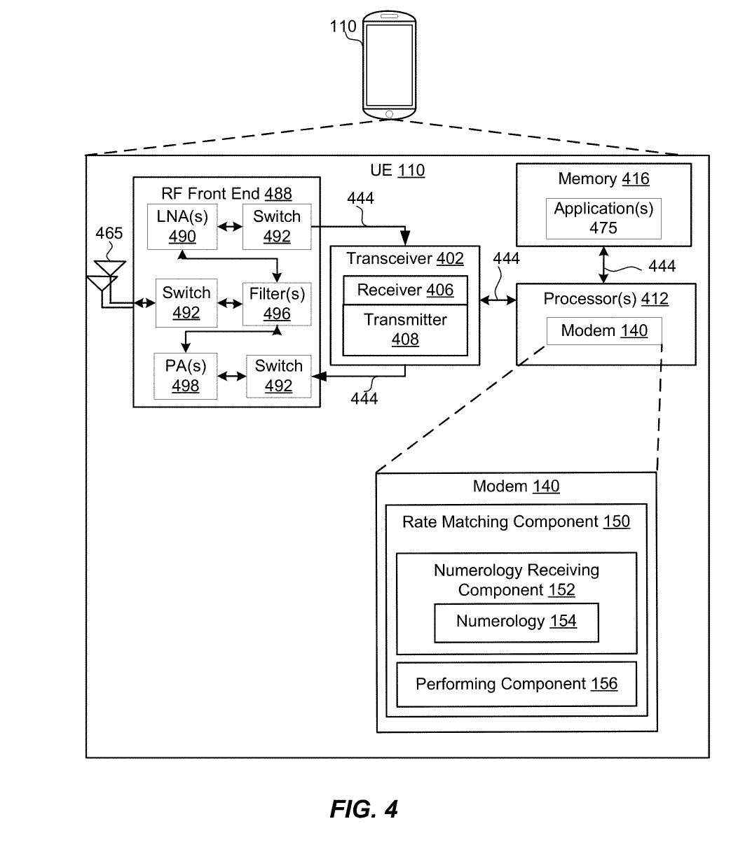

Referring to FIG. 4, one example of an implementation of UE 110 may include a variety of components, some of which have already been described above, but including components such as one or more processors 412 and memory 416 and transceiver 402 in communication via one or more buses 444, which may operate in conjunction with modem 140 and rate matching component 150 to enable one or more of the functions described herein related to rate matching and signaling. Further, the one or more processors 412, modem 414, memory 416, transceiver 402, RF front end 488 and one or more antennas 465, may be configured to support voice and/or data calls (simultaneously or non-simultaneously) in one or more radio access technologies.

In an aspect, the one or more processors 412 can include a modem 140 that uses one or more modem processors. The various functions related to rate matching component 150 may be included in modem 140 and/or processors 412 and, in an aspect, can be executed by a single processor, while in other aspects, different ones of the functions may be executed by a combination of two or more different processors. For example, in an aspect, the one or more processors 412 may include any one or any combination of a modem processor, or a baseband processor, or a digital signal processor, or a transmit processor, or a receiver processor, or a transceiver processor associated with transceiver 402. In other aspects, some of the features of the one or more processors 412 and/or modem 140 associated with rate matching component 150 may be performed by transceiver 402.

Also, memory 416 may be configured to store data used herein and/or local versions of applications 475 or rate matching component 150 and/or one or more of its subcomponents being executed by at least one processor 412. Memory 416 can include any type of computer-readable medium usable by a computer or at least one processor 412, such as random access memory (RAM), read only memory (ROM), tapes, magnetic discs, optical discs, volatile memory, non-volatile memory, and any combination thereof. In an aspect, for example, memory 416 may be a non-transitory computer-readable storage medium that stores one or more computer-executable codes defining rate matching component 150 and/or one or more of its subcomponents, and/or data associated therewith, when UE 110 is operating at least one processor 412 to execute rate matching component 150 and/or one or more of its subcomponents.

Transceiver 402 may include at least one receiver 406 and at least one transmitter 408. Receiver 406 may include hardware, firmware, and/or software code executable by a processor for receiving data, the code comprising instructions and being stored in a memory (e.g., computer-readable medium). Receiver 406 may be, for example, a radio frequency (RF) receiver. In an aspect, receiver 406 may receive signals transmitted by at least one base station 105. Additionally, receiver 406 may process such received signals, and also may obtain measurements of the signals, such as, but not limited to, Ec/Io, SNR, RSRP, RSSI, etc. Transmitter 408 may include hardware, firmware, and/or software code executable by a processor for transmitting data, the code comprising instructions and being stored in a memory (e.g., computer-readable medium). A suitable example of transmitter 408 may including, but is not limited to, an RF transmitter.

Moreover, in an aspect, UE 110 may include RF front end 488, which may operate in communication with one or more antennas 465 and transceiver 402 for receiving and transmitting radio transmissions, for example, wireless communications transmitted by at least one base station 105 or wireless transmissions transmitted by UE 110. RF front end 488 may be connected to one or more antennas 465 and can include one or more low-noise amplifiers (LNAs) 490, one or more switches 492, one or more power amplifiers (PAs) 498, and one or more filters 496 for transmitting and receiving RF signals.

In an aspect, LNA 490 can amplify a received signal at a desired output level. In an aspect, each LNA 490 may have a specified minimum and maximum gain values. In an aspect, RF front end 488 may use one or more switches 492 to select a particular LNA 490 and its specified gain value based on a desired gain value for a particular application.

Further, for example, one or more PA(s) 498 may be used by RF front end 488 to amplify a signal for an RF output at a desired output power level. In an aspect, each PA 498 may have specified minimum and maximum gain values. In an aspect, RF front end 488 may use one or more switches 492 to select a particular PA 498 and its specified gain value based on a desired gain value for a particular application.

Also, for example, one or more filters 496 can be used by RF front end 488 to filter a received signal to obtain an input RF signal. Similarly, in an aspect, for example, a respective filter 496 can be used to filter an output from a respective PA 498 to produce an output signal for transmission. In an aspect, each filter 496 can be connected to a specific LNA 490 and/or PA 498. In an aspect, RF front end 488 can use one or more switches 492 to select a transmit or receive path using a specified filter 496, LNA 490, and/or PA 498, based on a configuration as specified by transceiver 402 and/or processor 44.

As such, transceiver 402 may be configured to transmit and receive wireless signals through one or more antennas 465 via RF front end 488. In an aspect, transceiver may be tuned to operate at specified frequencies such that UE 110 can communicate with, for example, one or more base stations 105 or one or more cells associated with one or more base stations 105. In an aspect, for example, modem 140 can configure transceiver 402 to operate at a specified frequency and power level based on the UE configuration of UE 110 and the communication protocol used by modem 140.

In an aspect, modem 140 can be a multiband-multimode modem, which can process digital data and communicate with transceiver 402 such that the digital data is sent and received using transceiver 402. In an aspect, modem 140 can be multiband and be configured to support multiple frequency bands for a specific communications protocol. In an aspect, modem 140 can be multimode and be configured to support multiple operating networks and communications protocols. In an aspect, modem 140 can control one or more components of UE 110 (e.g., RF front end 488, transceiver 402) to enable transmission and/or reception of signals from the network based on a specified modem configuration. In an aspect, the modem configuration can be based on the mode of the modem and the frequency band in use. In another aspect, the modem configuration can be based on UE configuration information associated with UE 110 as provided by the network during cell selection and/or cell reselection.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method of wireless communications, comprising:
receiving, at a user equipment (UE), a numerology of a signal received from a base station, wherein the numerology indicates one or more parameters of a waveform associated with the signal; and
performing, at the UE, a rate matching based at least on the numerology, wherein the rate matching is performed for decoding the signal received from the base station.

2. The method of claim 1, wherein the one or more parameters comprise a subcarrier spacing, a cyclic prefix, or a combination thereof.

3. The method of claim 1, wherein the numerology is indicated via at least one of a layer one (L1) or radio resource control (RRC) signaling, a media access control-control element (MAC-CE), a master information block (MIB), a system information block (SIB), or a combination thereof.

4. The method of claim 1, wherein the UE is a first UE, wherein the numerology comprises a first subcarrier spacing for the first UE, a second subcarrier spacing for a second UE, or a combination thereof, and wherein the performing further comprises:
performing the rate matching for at least one of the first UE based at least on the first subcarrier spacing, performing the rate matching for the second UE based at least on the second subcarrier spacing, or a combination thereof.

5. The method of claim 4, wherein at least the first UE or the second UE are a plurality of UEs.

6. The method of claim 1, wherein the numerology comprises a first subcarrier spacing for control signaling of the UE, a second subcarrier spacing for data signaling of the UE, or a combination thereof.

7. The method of claim 6, further comprising:
dynamically changing a subcarrier spacing from the first subcarrier spacing to the second subcarrier spacing via a layer 1 (L1) control channel.

8. The method claim 1, wherein the numerology is indicated via one or more reserved bits.

9. The method of claim 1, further comprising:
performing, at the UE, a rate matching for uplink transmissions to the base station based at least on the numerology received from the base station.

10. An apparatus for wireless communications, comprising:
a memory configured to store data; and
one or more processors communicatively coupled with the memory, wherein the one or more processors and the memory are configured to:
receive, at a user equipment (UE), a numerology of a signal received from a base station, wherein the numerology indicates one or more parameters of a waveform associated with the signal; and
perform, at the UE, a rate matching based at least on the numerology, wherein the rate matching is performed for decoding the signal received from the base station.

11. The apparatus of claim 10, wherein the one or more parameters comprise a subcarrier spacing, a cyclic prefix, or a combination thereof.

12. The apparatus of claim 10, wherein the one or more processors and the memory are further configured to indicate the numerology via a layer one (L1) or radio resource control (RRC) signaling, a media access control-control element (MAC-CE), a master information block (MIB), a system information block (SIB), or a combination thereof.

13. The apparatus of claim 10, wherein the UE is a first UE, wherein the numerology comprises a first subcarrier spacing for the first UE, a second subcarrier spacing for a second UE, or a combination thereof, and wherein the one or more processors and the memory are further configured to:
perform the rate matching for at least one of the first UE based at least on the first subcarrier spacing, performing the rate matching for the second UE based at least on the second subcarrier spacing, or a combination thereof.

14. The apparatus of claim 13, wherein at least the first UE or the second UE are a plurality of UEs.

15. The apparatus of claim 10, wherein the numerology comprises a first subcarrier spacing for control signaling of the UE, a second subcarrier spacing for data signaling of the UE, or a combination thereof.

16. The apparatus of claim 15, wherein the one or more processors and the memory are further configured to:
dynamically change a subcarrier spacing from the first subcarrier spacing to the second subcarrier spacing via a layer 1 (L1) control channel.

17. The apparatus claim 10, wherein the numerology is indicated via one or more reserved bits.

18. The apparatus of claim 10, wherein the one or more processors and the memory are further configured to:
perform, at the UE, a rate matching for uplink transmissions to the base station based at least on the numerology received from the base station.

19. An apparatus for wireless communications, comprising:
means for receiving, at a user equipment (UE), a numerology of a signal received from a base station, wherein the numerology indicates one or more parameters of a waveform associated with the signal; and
means for performing, at the UE, a rate matching based at least on the numerology, wherein the rate matching is performed for decoding the signal received from the base station.

20. The apparatus of claim 19, wherein the one or more parameters comprise a subcarrier spacing, a cyclic prefix, or a combination thereof.

21. The apparatus of claim 19, wherein the numerology is indicated via at least one of a layer one (L1) or radio resource control (RRC) signaling, a media access control-control element (MAC-CE), a master information block (MIB), a system information block (SIB), or a combination thereof.

22. The apparatus of claim 19, wherein the UE is a first UE, wherein the numerology comprises a first subcarrier spacing for the first UE, a second subcarrier spacing for a second UE, or a combination thereof, and wherein the performing further comprises:
means for performing the rate matching for at least one of the first UE based at least on the first subcarrier spacing, performing the rating matching for the second UE based at least on the second subcarrier spacing, or a combination thereof.

23. The apparatus of claim 22, wherein at least the first UE or the second UE comprise a plurality of UEs.

24. The apparatus of claim 19, wherein the numerology comprises a first subcarrier spacing for control signaling of the UE, a second subcarrier spacing for data signaling of the UE, or a combination thereof.

25. The apparatus of claim 24, further comprising:
means for dynamically changing a subcarrier spacing from the first subcarrier spacing to the second subcarrier spacing via a layer 1 (L1) control channel.

26. The apparatus claim 19, wherein the numerology is indicated via one or more reserved bits.

27. The apparatus of claim 19, further comprising:
means for performing, at the UE, a rate matching for uplink transmissions to the base station based at least on the numerology received from the base station.

28. A computer readable medium storing computer executable code for wireless communications, comprising:
code for receiving, at a user equipment (UE), a numerology of a signal received from a base station, wherein the numerology indicates one or more parameters of a waveform associated with the signal; and
code for performing, at the UE, a rate matching based at least on the numerology, wherein the rate matching is performed for decoding the signal received from the base station.

29. The computer readable medium of claim 28, wherein the one or more parameters comprise a subcarrier spacing, a cyclic prefix, or a combination thereof.

30. The computer readable medium of claim 28, wherein the numerology is indicated via at least one of a layer one (L1) or radio resource control (RRC) signaling, a media access control-control element (MAC-CE), a master information block (MIB), a system information block (SIB), or a combination thereof.
